(19) United States
(12) Patent Application Publication
(10) Pub. No.: US 2026/0228484 A1
(43) Pub. Date: Aug. 6, 2026

(54) METHODS AND APPARATUSES FOR TRAINING AND USING A GRAPH NEURAL NETWORK

(71) Applicant: Telefonaktiebolaget LM Ericsson (publ), Stockholm (SE)

(72) Inventors: Jared KEOWN, Sundbyberg (SE); Víctor BUENESTADO GARCÍA, MÁLAGA (ES); Anderson FALCI, São Paulo (BR); Raúl MARTÍN CUERDO, MADRID (ES)

(21) Appl. No.: 19/126,491

(22) PCT Filed: Jan. 23, 2023
(86) PCT No.: PCT/SE2023/050053

§ 371 Date: May 1, 2025

(30) Foreign Application Priority Data
Nov. 2, 2022 (EP) 22383055.5

(51) Int. Cl. G06N 3/042; G06N 3/0464

(52) U.S. Cl. CPC G06N 3/042; G06N 3/0464

(57) ABSTRACT

Embodiments described herein relate to methods and apparatuses for training and using a graph neural network, GNN. The method of training comprises: inputting first training information into a first graph convolution layer of the GNN, wherein the first training information comprises: initial performance metrics of the plurality of nodes, subsequent configurations for the plurality of nodes, and an indication of relationships between the plurality of nodes; applying weighting parameters to the training information in the first graph convolution layer to determine a set of first feature vectors for each of the plurality of nodes; deriving predicted performance metrics for each of the plurality of nodes from the set of first feature vectors; and updating the weighting parameters based a loss function, wherein the loss function is calculated based on: predicted performance metrics associated with a set of training nodes in the plurality of nodes, and actual performance metrics resulting from applying the corresponding subsequent configurations to the set of training nodes.

### TECHNICAL FIELD

Embodiments described herein relate to methods and apparatuses for training and using a graph neural network, GNN. In particular the GNN may be trained to predict the effect that changes to configurations of the plurality of nodes will have on the collective performance of the plurality of nodes. The use of the GNN may be such that recommended configurations for the plurality of nodes may be determined that improve a collective estimated performance of the plurality of nodes.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

Uplink performance is important for complex networks (e.g., Communication networks like Fourth Generation (4G), Fifth Generation (5G), Sixth Generation (6G) and beyond) as it limits and impacts end user experience. Degradation of uplink performance can be due to different root causes, such as infrastructure, high traffic on the neighbor's cell edges, interference from internal or external sources, etc.

By tuning received power parameters the impact of existing neighbor traffic related interference or external source interference may be mitigated, however, this tuning is actuated by modifying the user equipment's uplink transmitted power, which ultimately can alter the uplink environment of the close by cells

It may therefore be considered crucial to provide a framework that considers the cross-impact and mutual influence of close-by cells when adjusting cell parameters

Optimization and tuning of uplink performance may require study of network statistics, network configuration, radio frequency (RF) environment, and investigation to successfully make recommendations for uplink performance parameters to address the degradation within the limitations of eNodeB/gNodeB settings.

Today there are several approaches aiming to provide such a framework. For example, a traditional approach based on deterministic rules may be used to deal with a source cell's uplink environment. However, this does not consider the impact of the changes to the source cell on neighboring cells, nor is it able to estimate in advance the impact of the actuation on both the source cell and the neighbor cell's uplink environment. The traditional approach also has a limited ability to be adapted to all variants of source cell environments, and it is not scalable solution because of the manual effort involved.

A regressor model based on neural networks (see for example WO2021/170617) may also be used. In this example, the input of the regressor model may comprise a graph network in which the nodes comprise the source cell and the influencing neighbors and their performance features, and in which the edges comprise the strength of the mutual influence between the respective cells. A regressor model such as this may be able to estimate in advance the impact of the recommendation in uplink performance in both the source cell and the influencing neighbors.

However, a regressor model may only be able to deal with one recommendation at a time in overlapping areas and a conflict resolution mechanism may limit the ability to deal with several recommendations that affect common neighbors in overlapping subgraphs.

A reinforcement learning approach is typically suggested to mitigate the conflicting proposals in overlapping areas. The RL agent may monitor through the reward function the impact on the neighbors in a reactive way. Aggregation of per cell agent weights into the global one makes the RL model to converge after several iterations to an optimum proposal dealing with overlapping recommendations based on the iterative process and the reward information. However, the RL agent is not able to estimate the impact of the recommendations in advance, and this can lead to a suboptimal situation for as if the dynamic range of the parameter to be set is wide, and the size of the step changes is low, the number of required iterations may be high, and the end user performance can be impacted during the overall process. This drawback may be mitigated by increasing the size of the step. A larger step size may shorten the iterative period but may lead to a suboptimal solution.

### SUMMARY

According to some embodiments there is provided a computer-implemented method of a training a graph neural network, GNN comprising a plurality of nodes and a plurality of edges. The method comprises inputting first training information into a first graph convolution layer of the GNN, wherein the first training information comprises: initial performance metrics of the plurality of nodes, subsequent configurations for the plurality of nodes, and an indication of relationships between the plurality of nodes; applying weighting parameters to the training information in the first graph convolution layer to determine a set of first feature vectors for each of the plurality of nodes; deriving predicted performance metrics for each of the plurality of nodes from the set of first feature vectors; and updating the weighting parameters based a loss function, wherein the loss function is calculated based on: predicted performance metrics associated with a set of training nodes in the plurality of nodes, and actual performance metrics resulting from applying the corresponding subsequent configurations to the set of training nodes.

According to some embodiments there is provided a computer-implemented method of using a graph neural network, GNN, to determine recommended configurations for a plurality of nodes, wherein the GNN comprises the plurality of nodes and a plurality of edges. The method comprises: i) for each first node in a candidate set from the plurality of nodes:

utilizing the GNN to select a selected configuration from a plurality of test configurations for the first node, whilst considering only changes to the configuration of the first node in conjunction with current configurations for the other of the plurality of nodes, ii) inputting, in conjunction, the selected configurations for the candidate set into the GNN; iii) outputting, from the GNN, for each of the plurality of nodes, first estimates of one or more performance metrics; iv) determining, based on the first estimates, one or more improved configurations from the selected configurations that improve a collective estimated performance of the plurality of nodes; v) updating the current configurations for the plurality of nodes with the one or more improved configurations; and vi) repeating steps i) to v) with the current configurations for the plurality of nodes.

According to some embodiments there is provided a computer-implemented method of using a graph neural network, GNN, to determine configurations of a plurality of nodes, wherein the GNN comprises the plurality of nodes and a plurality of edges. The method comprises inputting, in combination, one or more initial performance metrics and current configurations for the plurality of nodes into the GNN; outputting, from the GNN, one or more predicted performance metrics for each of the plurality of nodes; and for each node in the plurality of nodes: calculating a gradient by determining a loss function based on the one or more predicted performance metrics and the one or more initial performance metrics; and updating the current configuration for the node based on the gradient.

According to some embodiments there is provided a training node for training a graph neural network, GNN comprising a plurality of nodes and a plurality of edges. The training node comprises processing circuitry configured to cause the training node to: input first training information into a first graph convolution layer of the GNN, wherein the first training information comprises: initial performance metrics of the plurality of nodes, subsequent configurations for the plurality of nodes, and an indication of relationships between the plurality of nodes; apply weighting parameters to the training information in the first graph convolution layer to determine a set of first feature vectors for each of the plurality of nodes; derive predicted performance metrics for each of the plurality of nodes from the set of first feature vectors; and update the weighting parameters based a loss function, wherein the loss function is calculated based on: predicted performance metrics associated with a set of training nodes in the plurality of nodes, and actual performance metrics resulting from applying the corresponding subsequent configurations to the set of training nodes.

According to some embodiments there is provided a recommender node for using a graph neural network, GNN, to determine recommended configurations for a plurality of nodes. The GNN comprises the plurality of nodes and a plurality of edges. The recommender node comprises processing circuitry configured to cause the recommender node to: i) for each first node in a candidate set from the plurality of nodes: utilize the GNN to select a selected configuration from a plurality of test configurations for the first node, whilst considering only changes to the configuration of the first node in conjunction with current configurations for the other of the plurality of nodes, ii) input, in conjunction, the selected configurations for the candidate set into the GNN; iii) output, from the GNN, for each of the plurality of nodes, first estimates of one or more performance metrics; iv) determine, based on the first estimates, one or more improved configurations from the selected configurations that improve a collective estimated performance of the plurality of nodes; v) update the current configurations for the plurality of nodes with the one or more improved configurations; and vi) repeat steps i) to v) with the current configurations for the plurality of nodes.

According to some embodiments there is provided a recommender node for using a graph neural network, GNN, to determine recommended configurations for a plurality of nodes, wherein the GNN comprises the plurality of nodes and a plurality of edges. The recommender node comprises processing circuitry configured to cause the recommender node to: input, in combination, one or more initial performance metrics and current configurations for the plurality of nodes into the GNN; output, from the GNN, one or more predicted performance metrics for each of the plurality of nodes; and for each node in the plurality of nodes: calculate a gradient by determining a loss function based on the one or more predicted performance metrics and the one or more initial performance metrics; and update the current configuration for the node based on the gradient.

Aspects and examples of the present disclosure thus provide methods and apparatuses for training and using a GNN. The trained GNN is able to predict the performance of all of a plurality of nodes in response to simultaneous changes to configurations of one or more of the plurality of nodes.

An objective problem to be solved by the invention may therefore be how to improve a collective performance of the plurality of nodes as a whole. The method of training a GNN provides a GNN than may then be used in methods described herein to solve the aforementioned problem.

### BRIEF DESCRIPTION OF THE DRAWINGS

For a better understanding of the embodiments of the present disclosure, and to show how it may be put into effect, reference will now be made, by way of example only, to the accompanying drawings, in which:

FIG. 1 illustrates an example of a method performed by a system configured to use a trained GNN to determine configurations for a plurality of nodes;

FIG. 2 illustrates an example of a GNN according to some embodiments;

FIG. 3 illustrates a method of a training a graph neural network, GNN comprising a plurality of nodes and a plurality of edges;

FIG. 4 illustrates an example graph convolution layer;

FIG. 5 illustrates an example of a set of training nodes according to some embodiments;

FIG. 6 illustrates an example of a how test configurations may be input into a trained GNN to determine predicted performance parameters;

FIG. 7 illustrates a method of using a graph neural network, GNN, to determine configurations for a plurality of nodes;

FIG. 8 illustrates an example implementation of the method of FIG. 7;

FIG. 9 illustrates an example of the evolution of the first cost function after each iteration, for 25 iterations;

FIG. 10 illustrates a method of using a graph neural network, GNN, to determine configurations of a plurality of nodes;

FIG. 11 illustrates a training node comprising processing circuitry;

FIG. 12 illustrates a recommender node comprising processing circuitry;

FIG. 13 illustrates a recommender node comprising processing circuitry.

### DESCRIPTION

The following sets forth specific details, such as particular embodiments or examples for purposes of explanation and not limitation. It will be appreciated by one skilled in the art that other examples may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialized function, ASICs, PLAS, etc.) and/or using software programs and data in conjunction with one or more digital microprocessors or general purpose computers. Nodes that communicate using the air interface also have suitable radio communications circuitry. Moreover, where appropriate the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analogue) circuitry including but not limited to application specific integrated circuit(s) (ASIC) and/or field programmable gate array(s) (FPGA(s)), and (where appropriate) state machines capable of performing such functions.

Embodiments described herein provide methods and apparatuses for training and using a graph neural network comprising a plurality of nodes. In particular, the graph neural network is capable of predicting the effect of applying different configurations (e.g. using different settings for adjustable parameters at the nodes) on the plurality of nodes in the graph.

In particular embodiments described herein focus on an intelligent recommender system that consists of a combination of a Graph Neural Network (GNN) trained in the overall area of analysis, and either a non-convex optimization process to use the trained GNN to find the optimal scenario by iterating offline over the different configurations to be applied to the nodes, or a method of using the GNN utilising gradient descent or ascent to adjust the configurations at the plurality of nodes whilst maintaining fixed parameters for the trained GNN.

Some embodiments described herein utilise a GNN to determine configuration parameters for a graph-based system (e.g. a cellular network) that improves a collective estimated performance of the graph-based system.

Some examples described herein provide a method to transform raw data into a graph suitable for modelling with a GNN.

Some examples described herein provide a GNN regression model architecture that learns how neighbouring graph nodes affect a given node's performance metric. The architecture is flexible for a variable number of neighbouring nodes and adaptable to scenarios when multi-hop neighbours may impact a node's performance metric.

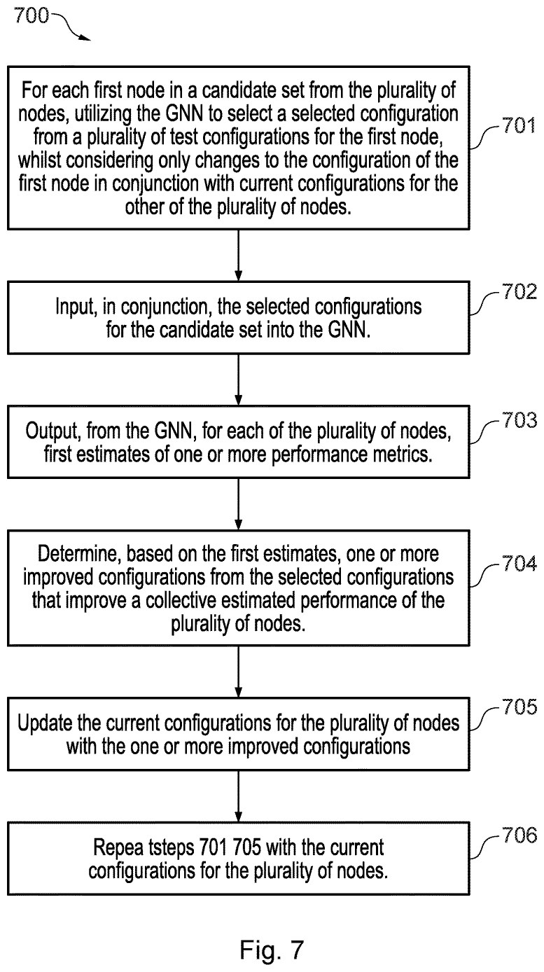

Some examples described herein (e.g., as described with reference to FIGS. 7 to 9) provide a non-convex optimization process that probes the GNN's predictions to find the input configurations that improve a collective performance across all nodes in the graph. The process may be iterated in order to converge to a global or local optimum for the configurations of the nodes in the graph. A local optimum may comprise an optimum solution within a neighbouring set of candidate solutions. The global optimum may comprise the optimum solution among all possible solutions.

The process described is adaptable to a variable amount of parameters in the input configurations, as well as a variable number of performance metrics that can be considered during the process.

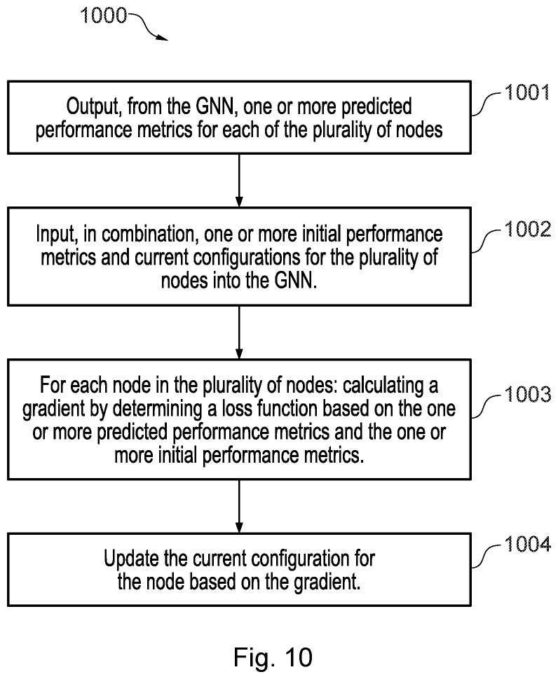

Some examples described herein (e.g., as described with reference to FIG. 10) provide a gradient-based method using the GNN to determine configurations for the plurality of nodes that improve a collective performance across all nodes in the GNN. The gradient-based method may be scalable to use-cases involving a large number of nodes in the graph.

The proposed framework is generic and may be applied to different graph problems, for example, radio network optimization problems where the influence of the neighboring cells and the pre-estimation of the impact of the proposals is crucial. For example, the trained GNN may be applied to uplink power control parameter optimization in order to improve the collective uplink performance of a plurality of cells. Herein, this example may be referred to as the uplink performance scenario. In this example, nodes in the graph comprise different cells and edges in the graph comprise the relationship between the cells.

The methods described herein may also be applied to social networks where the goal is to assign a certain advertisement profile to each user (nodes in the GNN) based on their interactions with the social media platform and their interactions (edges in the GNN) with friends on the platform. In this case the ad profile would be the configurations that the methods described herein may be used to find an optimal or improved setting for. The performance metrics may comprise how often a user clicks on the ads they receive.

In another example, the methods described herein may be applied to a network of robots in a factory (nodes in the GNN) where the goal is to position the robots on the factory floor in a way that is optimal to the task they are performing. The graph nodes may comprise the robots and the communication signals they send/receive to one-another may comprise the edges in the GNN. The configurations that may be adjusted may comprise the X, Y coordinates of the robots on factory floor and the performance metrics may comprise the production efficiency of the robots or perhaps a metric evaluating how safe the robots are in performing the tasks.

In another example the methods described herein may be applied to a plurality of self-driving cars (e.g., nodes in the GNN) that communicate with one another (edges in the GNN), where the performance metric comprises the efficiency of their movements through a city.

During some of the rest of the document, an implementation of the generic approach to targeting uplink power control parameter optimization in order to improve a cell's uplink performance is used to illustrate the concept. It will be appreciated that the concepts described may be equally applied to any of the above examples or any other suitable scenarios.

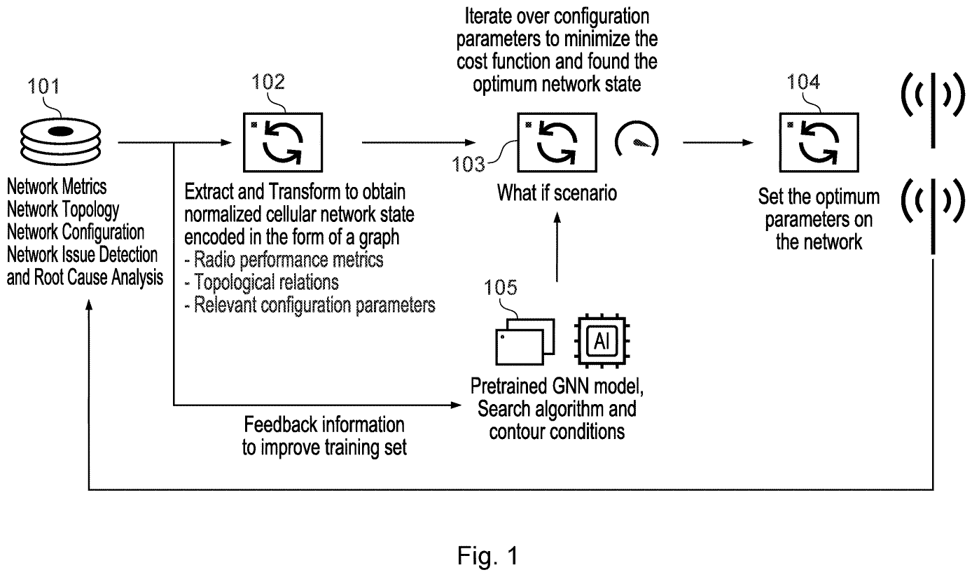

FIG. 1 illustrates an example of a method performed by a system configured to use a trained GNN to determine configurations for a plurality of nodes. In the example illustrated in FIG. 1, the plurality of nodes comprises a plurality of network nodes (e.g., base stations in a communication network).

The system in step 101 may extract information from the plurality of nodes. For example, the system may extract network performance metrics, configurations for the nodes, network topology information, network issue detections and root cause analysis information. This information may then be organized in step 102 into time series data comprising: performance metric information for each of the plurality of nodes, and configurations for each of the plurality of nodes. The configuration of a particular node may comprise particular values of one or more adjustable parameters at that node.

For example, the configurations may comprise values of a target uplink received power and a pathloss compensation factor.

In some examples, data may be collected over a plurality of time periods (e.g., a plurality of days).

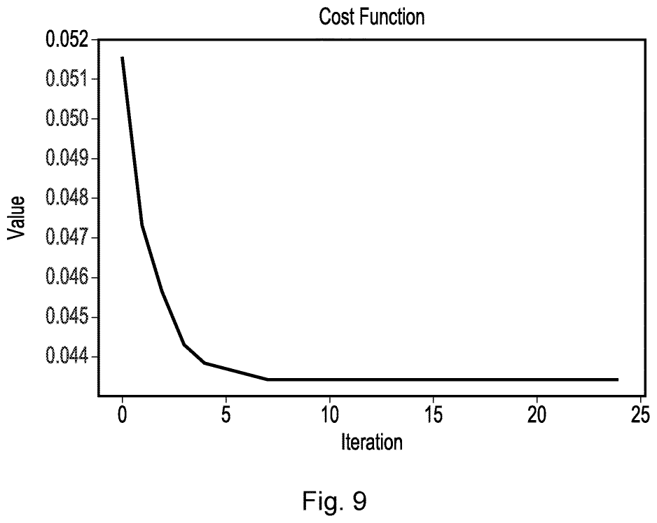

The data from each single time period (e.g., from each day) may then be input in step 103 into a process that utilizes the trained GNN (for example a process such as that described later with reference to FIG. 7 or 9 or with reference to FIG. 10). The process utilizing the GNN may then output a recommendation for updated configurations for the plurality of nodes.

The process may output a plurality of recommendations, one for each time period over which data has been collected. For example, if X (where X is an integer number) days of data is collected from the plurality of nodes, the process may be run on the data from each of those days individually to provide X independent “proposals” for configurations at the plurality of nodes (where proposals refers to the output of the search process on that single day we ran it for). These X configuration proposals may or may not be in agreement with one another due to the daily variations in the data (i.e., daily metrics fluctuations), so a final step may be implemented that aggregates the proposals into a final recommendation that may be applied to the plurality of nodes in step 104. Note that in the description above the time period may comprise any suitable time period e.g., one hour, one day one week etc. and the data may be collected for any number of time periods e.g., 7 days, 24 hours, 3 weeks etc.

It will be appreciated that the GNN may continue to retrain in step 105 based on the online data collected from the plurality of nodes.

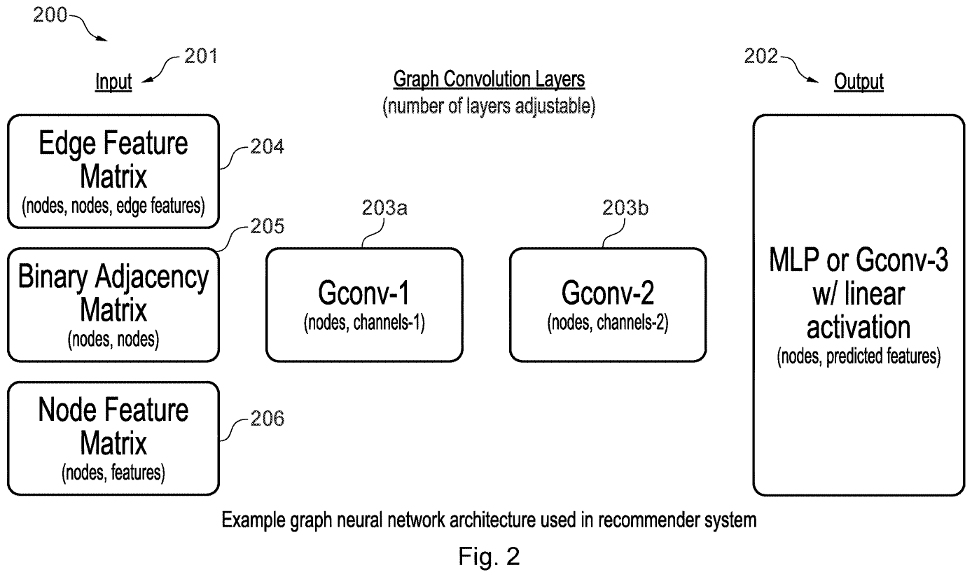

FIG. 2 illustrates an example of a GNN according to some embodiments. The GNN 200 may be utilized in the system of FIG. 1.

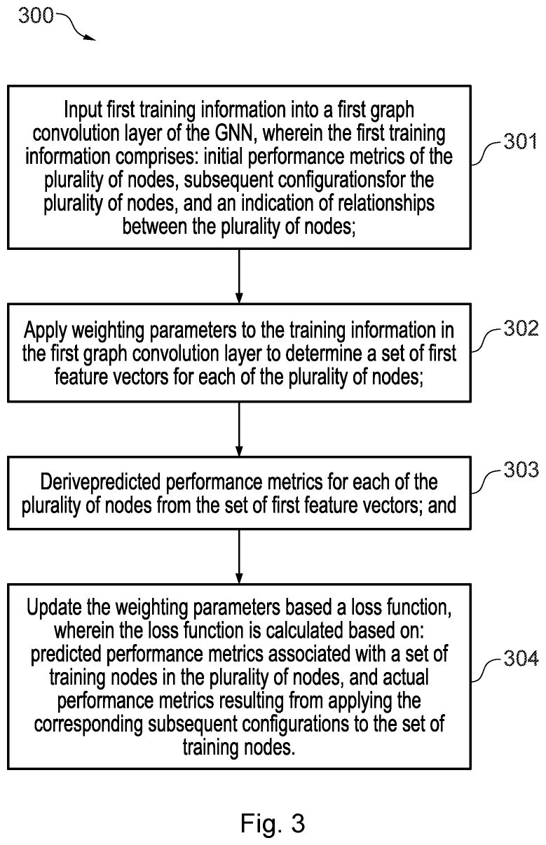

The GNN may receive as input the following information at an input layer 201: initial performance metrics of the plurality of nodes, subsequent configurations for the plurality of nodes, and an indication of relationships between the plurality of nodes. In particular, this information may be arranged into three matrices as will be described in more detail below (with reference to FIG. 3).

Based on this information, the GNN may output predicted performance metrics in an output layer 202. In other words, the GNN may predict the effect the subsequent configurations will have on the performance of the plurality of nodes given the initial performance metrics of the plurality of nodes.

The GNN may comprise a plurality of convolution layers 203 between the input layer and the output layer. In this example two convolution layers are illustrated, 203a and 203b.

During training (as will be described with reference to FIG. 3 below), the GNN will receive training information as an input. The output predicted performance metrics may then be compared to actual performance metrics in historical data that resulted from applying the subsequent configurations. The parameters (e.g., weights) in the GNN may then be updated based on the comparison.

FIG. 3 illustrates a method of training a graph neural network, GNN (e.g. GNN 200) comprising a plurality of nodes and a plurality of edges. It will be appreciated that the GNN of FIG. 2 may be trained according to method described with reference to FIG. 3.

The method 300 may be performed by a network node, which may comprise a physical or virtual node, and may be implemented in a computing device or server apparatus and/or in a virtualized environment, for example in a cloud, edge cloud or fog deployment.

Step 301 comprises inputting first training information into a first graph convolution layer of the GNN (e.g., layer 203a as illustrated in FIG. 2), wherein the first training information comprises: initial performance metrics of the plurality of nodes, subsequent configurations for the plurality of nodes, and an indication of relationships between the plurality of nodes.

For the uplink performance scenario, two raw data sources may be Performance Management (PM) and Configuration Management (CM) data collected at the cell level across the radio access network.

The initial performance metrics may therefore comprise cell Key Performance Indicators (KPIs). For example, the initial performance metrics may comprise value of one or more of: average throughput, total data volume, and average pathloss, average active users, average uplink noise level, average channel quality indicator, and average signal to noise plus interference ratio (SINR).

The indication of relationships between the plurality of nodes may comprise an indication of whether any relationship exists between two nodes. For example, in the uplink performance scenario, a relationship may exist between any two cells if there has been any form of recorded interaction between the cells, e.g., a handover or an interference measurement.

The indication of relationships may in some examples further comprise relationship performance metrics (e.g., relationship KPIs). These relationship KPIs may indicate a performance of relationships between nodes. For the uplink performance scenario, for example, these relationship KPIs may capture not only which cells in the network are interacting with others, but also the intensity and quality of those interactions. Relationship KPIs may be bi-directional, e.g., the relationship KPIs from Cell A to Cell B can be different from those characterizing the Cell B to Cell A interaction. The relationship performance metrics may, for example, comprise one or more of: handover rates between the nodes, cell coverage overlap fractions of the nodes, and distance between nodes.

The subsequent configurations may comprise value settings for one or more configuration parameters for each of the plurality of nodes. For the uplink performance scenario, the subsequent configurations may comprise values for a target uplink received power (pZeroNominalPusch) and a pathloss compensation factor (alpha), which are parameters within each cell that drive an uplink power control loop.

pZeroNominalPusch indicates the target uplink received power of the wireless devices, at the base station end, within a cell's coverage area and typically ranges from ~−120 dBm to −80 dBm in most networks. Alpha is the pathloss compensation factor that sets whether wireless devices far from a cell center are required to transmit at higher power levels than those closer to the cell center. Alpha is a unitless fraction that ranges from 0 to 1, with 0 indicating that all wireless devices in the cell transmit at the same power and 1 indicating cells at the border will be transmitting at their maximum allowed power.

In some examples, the tabular PM/CM data may be collated into a graph structure comprising nodes and edges. For the uplink performance scenario every node represents a unique cell in the network and every edge represents a cell relation.

Referring to the input layer 201 illustrated in FIG. 2, the first training information utilized in step 301 may therefore comprise:
1. A first matrix 204 comprising the subsequent configurations of the plurality of nodes and the initial performance metrics of the plurality of nodes. The first matrix may be referred to as a node feature matrix. In the uplink performance scenario, the first matrix may comprise a 2D matrix (number of nodes by number of node features) where each row represents a unique cell in the RAN and each column is a different node feature. Note that the one or more adjustable parameters of the subsequent configurations (e.g. pZeroNominalPusch and alpha), are concatenated with the initial performance metrics (e.g. cell KPIs) to create the node features of the first matrix;
2. A second matrix 205 comprising the indication of relationships between the plurality of nodes. The second matrix may be referred to as an adjacency matrix. In the uplink performance scenario, the second matrix may comprise a 2D matrix (number of nodes by number of nodes) where each row represents a unique cell in the network and each column represents that cell's relationship to all other cells in the graph. This matrix may be binary (comprising values of either 0 or 1), with 1 indicating a relationship is present between two cells and 0 indicating the cells are not related; and
3. A third matrix 206 comprising relationship performance metrics associated with the relationships between the plurality of nodes. The third matrix may be referred to as an edge feature matrix. The third matrix may comprise a 3D matrix (number of nodes, number of nodes by number of relations by edge features) where the first two axes are the same as the adjacency matrix and the third dimension contains the relational features for all the cell-to-cell relationships.

Data input from multiple time periods (e.g., multiple days) may be considered for a given node for time stable proposals. Each time period may be being managed independently in the graph.

In step 302 the method comprises applying weighting parameters to the training information in the first graph convolution layer to determine a set of first feature vectors for each of the plurality of nodes. For example, the first graph convolution layer may comprise an adjustable number of artificial neurons or “channels” that dictate the shape of the output of the first graph convolution layer. The first graph convolution layer therefore has two dimensions of size (number of nodes, number of channels).

In some examples, the first initial graph convolution layer may create a first feature vector for every node in the graph by aggregating information from each node's one-hop neighborhood (i.e., all nodes it shares an edge with) and its own features into a vector of length number of channels.

There are many types of graph convolution layer that may be used in the one or more graph convolution layers of the GNN, with each having a different way to aggregate the neighborhood features into a feature vector. It will be appreciated that any suitable graph convolution layer may be used.

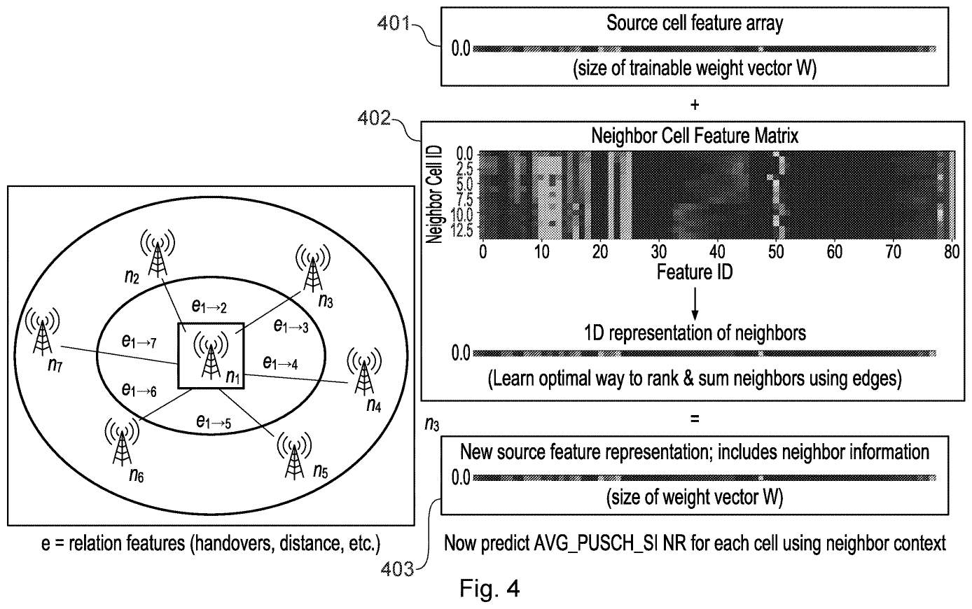

One example of a graph convolution layer, known as Edge-Conditioned Convolution (see for example, Simonovsky, M. and Komodakis, N., “Dynamic Edge-Conditioned Filters in Convolutional Neural Networks on Graphs”, arXiv e-prints, 2017. https://arxiv.org/abs/1704.02901) is illustrated in FIG. 4.

This example graph convolution layer trains a multi-layer perceptron on input edge features e_{i→j}, e.g., the relationship features between a source node nᵢ (for which the feature vector is to be created) and the neighboring nodes nⱼ. The graph convolution layer may then learn an optimal way to perform a weighted sum of the neighbor node features. This weighed sum may then be added to a separate encoding of the source node features created from another trainable weight vector Wᵣₒₒₜ to create an output feature vector for the source node nᵢ with information from the entire one-hop neighborhood that may be used in subsequent convolutional graph layers.

In other words, step 303 of FIG. 3 may comprise determining a first feature vector for a first node, nᵢ, by performing the following steps:
1) Apply a first weighting parameter, Wᵣₒₒₜ, to a first vector, xᵢ, of information in the first matrix associated with the first node. For example, the first vector may comprise the initial performance metrics and the subsequent configuration for the first node. This step represent the features of the first node in 1 dimensional vector 401 a with a training weighting parameter, Wᵣₒₒₜ.
2) For each neighboring node nⱼ of the first node nᵢ:
   a. Determine a second vector xⱼ, of information in the first matrix associated with the neighboring node, nⱼ. For example, the second vector xⱼ may comprise the initial performance metrics and the subsequent configuration for the neighboring node nⱼ; and
   b. Multiply the second vector by an output of a Multi-layer Perceptron, MLP, wherein MLP receives the relationship performance metrics, e_{i→j} associated with the relationship between the first node nᵢ and the neighboring node nⱼ as an input, to determine a third vector, xⱼMLP(e_{i→j}).
      As illustrated in graph 402, this step generates a 1-dimensional representation of the features of the neighboring nodes that may then be combined with the representation generated in step 1.
3) Calculate the first feature vector x′ᵢ (as illustrated in graph 403) as a sum of: the third vectors for all neighboring nodes nⱼ of the first node, the weighted first vector, and an offset value b.

In other words, the first feature vector, x′ᵢ may be calculated as:

$${x}_{i}^{′} = {x}_{i} {W}_{root} + {\sum }_{j ∈ N ( i )} {x}_{j} MLP ( {e}_{i \to j} ) ,$$

where

N(i) are the neighbors of the first node, nᵢ.

In step 303 the method of FIG. 3 comprises deriving predicted performance metrics for each of the plurality of nodes from the set of first feature vectors.

In some examples, step 303 comprises inputting the set of first feature vectors into a second graph convolution layer. It will be appreciated that any number of graph convolution layers may be used. In some examples, the first feature vectors may be used to make a prediction in the output layer 202.

In the former case, the output of the second stacked graph convolution layer (e.g., 203b) would encode information also from the once removed neighbors of each node. With each subsequent stacked graph convolution layer, N_conv, the feature vectors output by that graph convolution layer would include influence from a growing sphere of influence centered on each node and extending out to N_conv-hop neighbors.

Step 304 comprises updating the weighting parameters based a loss function calculated based on: the predicted performance metrics associated with a set of training nodes in the plurality of nodes, and actual performance metrics resulting from applying the corresponding subsequent configurations to the set of training nodes.

The loss function may, for example, comprise a regression loss function such as mean squared error (MSE) or mean absolute error (MAE). In some examples, the loss function may comprise a cross entropy loss function. The loss function may therefore comprise a comparison between the predicted performance metrics associated with the set of training nodes and the actual performance metrics associated with the set of training nodes.

For the example first graph convolution layer illustrated in FIG. 4, step 304 may comprise updating the first weighting parameter, Wᵣₒₒₜ and updating the parameters in the MLP.

In some examples, the set of training nodes comprises the plurality of nodes. However, in some examples the set of training nodes is selected from the plurality of nodes.

In other words, during training, a portion of the nodes are hidden such that their output predictions do not affect the weight updates of the GNN. These hidden nodes may instead be used after training to gauge performance of the GNN. For example, the method of FIG. 3 may further comprise testing an accuracy of the GNN utilizing first training information associated with one or more of the plurality of nodes not in the set of training nodes.

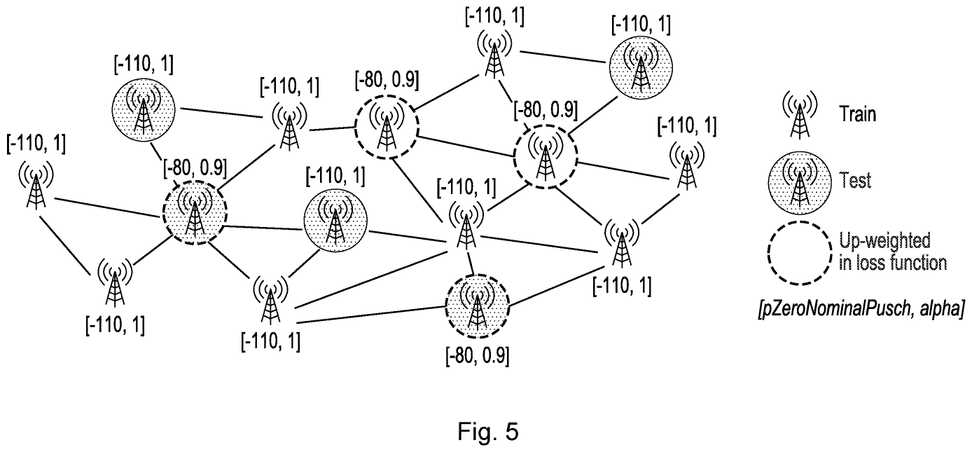

FIG. 5 illustrates an example of a set of training nodes according to some embodiments.

As illustrated in FIG. 5, in some examples, when calculating the loss function in step 304, some of the set of training nodes are up-weighted. For example, there may be an imbalance in the dataset (e.g., some combinations of pZeroNominalPusch and alpha settings in the dataset may be rare), and in these cases, the loss function used during training may be weighted so that the rarer samples have a higher importance in the loss function. This up-weighting of rare classes of nodes or settings encourages the GNN to learn to predict both rare and common settings well.

For example, for each of the set of training nodes the method of FIG. 3 may further comprise determining a node weighting value derived from a rarity of the subsequent configuration for the training node; and determining a weighted comparison by applying the node weighting value to a comparison between predicted performance metrics for the training node and actual performance metrics for the training node; and using the weighted comparison in the loss function.

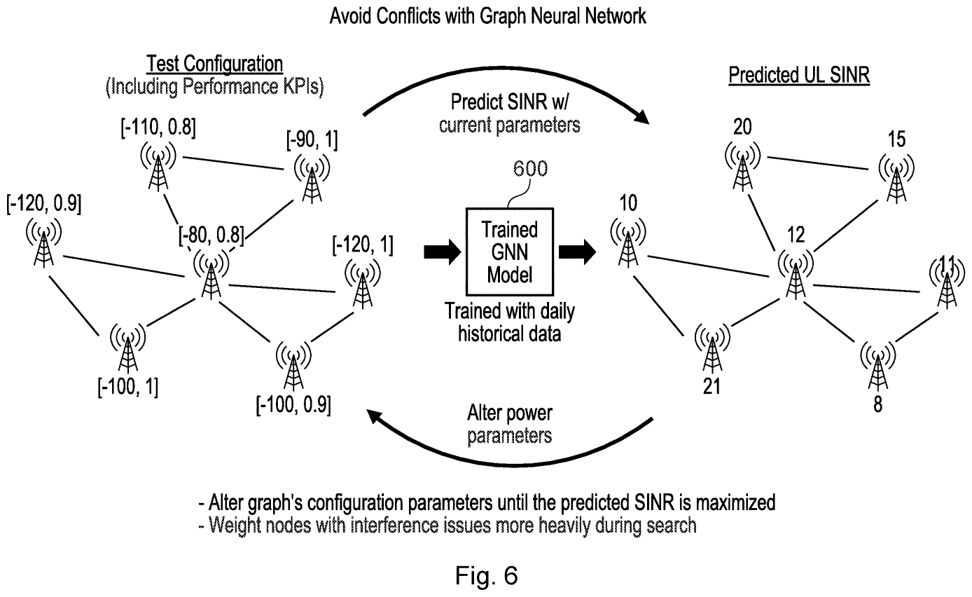

FIG. 6 illustrates an example of a how test configurations may be input into a trained GNN to determine predicted performance parameters.

In particular, the configurations for the nodes indicated in the lefthand depiction of a plurality of base stations may be input into the GNN 600 and the GNN 600 may then output the predicted performance parameters (e.g. SINR values) shown in the righthand depiction of the plurality of base stations.

The overall framework, illustrated in FIG. 6, is parallelized to be very efficient in time processing and considers performance metrics for the last 7 days to determine recommendations for altering the configurations of nodes in the network.

A secondary process combines the recommendations according to daily metrics fluctuation, so the overall effect is that final recommendation is time stable.

FIG. 7 illustrates a method of using a graph neural network, GNN, to determine configurations for a plurality of nodes. The GNN may be trained as described with reference to FIGS. 2 to 5. For example, the GNN may be trained to predict the effect that changes to adjustable parameters of the plurality of nodes will have on the collective performance of the plurality of nodes.

The method 700 may be performed by a network node, which may comprise a physical or virtual node, and may be implemented in a computing device or server apparatus and/or in a virtualized environment, for example in a cloud, edge cloud or fog deployment.

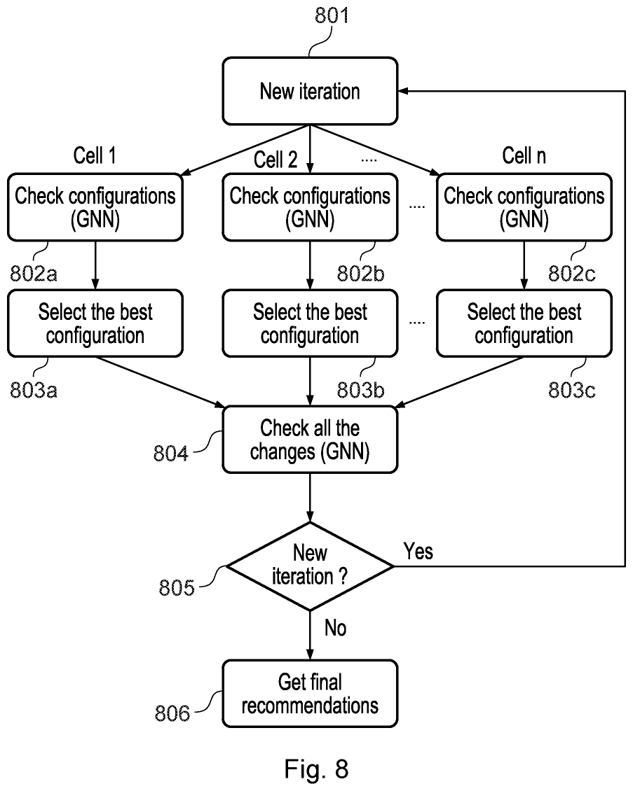

In step 701 the method comprises: for each first node in a candidate set from the plurality of nodes utilizing the GNN to select a selected configuration from a plurality of test configurations for the first node, whilst considering only changes to the configuration of the first node in conjunction with current configurations for the other of the plurality of nodes. Further detail of how step 701 may be implemented will be described in more detail with reference to FIG. 8.

The candidate set from the plurality of nodes may comprise nodes that would benefit from tuning of their configurations from a performance point of view. For example, the disclosures in WO2019/233635 or WO2020/164739 may be used to select candidate cells that would benefit from tuning of pZeroNominalPusch and alpha parameters from performance point of view. This filtering of nodes that are allowed to be tuned by the process of using the trained GNN is optional.

Step 702 comprises inputting, in conjunction (e.g. simultaneously), the selected configurations for the candidate set into the GNN. For example, step 702 may comprise inputting the selected configurations for the candidate set along with initial performance metrics as part of the first matrix 204 in the input layer 201 of the trained GNN (as illustrated in FIG. 2).

Step 703 comprises outputting, from the GNN, for each of the plurality of nodes, first estimates of one or more performance metrics.

Step 704 comprises determining, based on the first estimates, one or more improved configurations from the selected configurations that improve a collective estimated performance of the plurality of nodes. Step 704 may comprise utilizing a cost function to evaluate the cost of each selected configuration on the collective estimated performance of the plurality of nodes. An example implementation of step 704 will be described in more detail with reference to FIG. 8.

Step 705 comprises updating the current configurations for the plurality of nodes with the one or more improved configurations.

Step 706 comprises repeating steps 701 to 705 with the current configurations for the plurality of nodes.

In some examples, the method of FIG. 7 further comprises performing iterations of steps 701 to 706 until a stopping condition is reached, wherein the stopping condition comprises one of: a maximum number of iterations is reached, or the collective estimated performance converges. For example, the collective estimated performance may converge to a global or a local optimum.

In some examples the method of FIG. 7 further comprises, responsive to reaching the stopping condition, applying last updated current configurations to the plurality of nodes.

FIG. 8 illustrates an example implementation of the method of FIG. 7.

The process illustrated in FIG. 8 has been defined to find an optimal (or improved) scenario by iterating over the different configurations in a candidate set of nodes. The aim of this process is to propose final recommendations for configurations for each candidate node simultaneously.

Using the GNN described above, different test configurations are evaluated, estimating at once the one or more performance metrics for all the plurality of nodes in the entire GNN.

The inputs for this process may comprise the same matrices used to train the GNN (as described above). In some examples, the input also comprises a list of the candidate nodes where changes to configurations are desired or allowed. The outputs of the process of FIG. 8 comprises recommended configurations for each of the candidate nodes. In some examples, the process of FIG. 8 may also output a estimate of the impact of each new recommended configuration in both the relevant node and the influencing neighbor nodes.

Additionally, the process of FIG. 8 may work to provide a conflict resolution mechanism to deal with several recommended configurations from different source cells that affect common neighbors in overlapping subgraphs.

Step 801 of FIG. 8 indicates a new iteration of the method. For example, this indicates a new iteration of the implementation of steps 701 to 706 of FIG. 7.

Steps 802a to 802c and 803a to 803c are executed on a per node basis. These steps illustrate an example implementation of step 701 of FIG. 7.

In steps 802a to 802c the method comprises evaluating each candidate node individually (as if the rest of the plurality of nodes do not change their configurations) for finding a selected configuration (e.g. selected values of pZeroNominalPusch and alpha).

For that purpose, in each iteration, each candidate node and its neighbor nodes are identified. Note that this first step for finding the selected configurations for the candidate nodes may be performed in parallel in order to improve the execution time of the process of FIG. 8.

In steps 802a to 802c the method comprises using the trained GNN to test a plurality of configurations at each node. For example, step 802a tests a plurality of configurations for node 1, step 802b tests a plurality of configurations for node 2, and step 802n tests a plurality of configurations for node n.

Each configuration may for example comprise values of pZeroNominalPusch and alpha parameters for the node.

Steps 802a and 803a will now be described in more detail. It will be appreciated that steps 802b to 802n and 803b and 803n will correspond to steps 802a and 803a for the different nodes in the candidate nodes.

In step 802a, for each first configuration in a plurality of configurations the method may comprise the following steps:
i) Input the first configuration into the GNN in conjunction with current configurations for the other of the plurality of nodes. For example, the current configurations for the other of the plurality of nodes may comprise the values of pZeroNominalPusch and alpha that are currently being used in the other nodes in the network. These current configurations and the first configuration may then be combined with initial performance metrics to create the first matrix in the input layer of the GNN.
ii) Output, from the GNN, for each of the plurality of nodes, second estimates of the one or more performance metrics that would result from the first configuration. In other words, this step evaluates the effect of implementing the first configuration at the first node without considering any changes to configurations at other nodes.

In step 803a, selecting, based on the second estimates for each first configuration, a selected configuration for the first node from the plurality of configurations.

For example, step 803a may comprise calculating an initial cost for each first configuration. The initial cost may be calculated based on: the first configuration for the first node, the current configurations for the other of the plurality of nodes, and the second estimates of the one or more performance metrics resulting from the first configuration. The selected configuration may then be the first configuration associated with a best initial cost. It will be appreciated that the initial cost may be calculated in different ways and that therefore in some instances a lowest initial cost value will be considered a best initial cost, and in other instances a highest initial cost value will be considered a best initial cost.

In other words, once performance metrics are estimated for all the plurality of configurations for the first node, the selected configuration for the first node is selected based on an initial cost function that considers the performance estimated in the area of influence. In this way, the method is able to select a configuration that provides improvement in the performance of the first node whilst controlling any degradation of performance in neighboring nodes.

The initial cost function may be configurable for different targets and may be customized to optimize different aspects of node performance.

An example of an initial cost function that utilizes a Frobenius norm is:

$$initial cost = {\sum }_{i} {w}_{i} * {‖ {w}_{node} * Pj ‖}_{F} + {\sum }_{PM} {w}_{PM} * {‖ {w}_{node} * Δ {PM}_{2} ‖}_{F} ,$$

where:

each configuration at one of the plurality of nodes comprises one or more configuration parameters, i, Pi is a list of values for the configuration parameter i for all of the plurality of nodes; wᵢ is a weight for the configuration parameter i, ΔPM₂ is a list of differences between the second estimate of a performance metric PM and target for the performance metric PM for each of the plurality of nodes, w_{PM} is a weight for the performance metric PM; w_{node} is a list of weights for the plurality nodes.

The terms wᵢ and w_{PM} indicate the weight assigned to each target in the cost function whereas w_{node} are the node type weights of all the nodes. The weight values in w_{node} may be the same for all the nodes for having a uniform distribution, and a different weight may be used for candidate nodes and neighbor nodes.

The output of steps 803a to 803n is a selected configuration for each of the plurality of nodes.

After selecting the best configuration for each candidate node individually, a conflict management mechanism is executed in steps 804 to 805.

In step 804, the GNN is used again to evaluate simultaneously all the selected configurations for all of the candidate nodes. In other words, the selected configurations for the candidate nodes are input into the GNN simultaneously, along with current configurations for any of the plurality of nodes that are not in the candidate nodes. Step 804 comprises an example implementation of step 702 to 705 of FIG. 7.

Step 804 aims to determine which of the selected configurations improve a collective estimated performance of the plurality of nodes. Those of the selected configurations that improve the collective estimated performance of the plurality of nodes may be determined as “improved” configurations.

To do this step 804 may comprise the following steps:
i) Set the selected configurations as improved configurations. This initializes the group of improved configurations as all of the selected configurations. The following steps may then remove selected configurations from the group of improved configurations if it is determined that they do not improve the collective estimated performance of the plurality of nodes.
ii) Input the improved configurations into the GNN to determine first estimates of the one or more performance metrics
iii) Calculate a first cost value of the improved configurations. The first cost value may be indicative of the collective estimated performance of the plurality of nodes. The first cost value may be calculated based on the improved configurations and the current configurations for any nodes not associated with an improved configuration.

For example, the first cost value may be calculated as:

$$first cost = {\sum }_{i} {w}_{i} * {‖ {w}_{node} * Pi ‖}_{F} + {\sum }_{PM} {w}_{PM} * {‖ {w}_{node} * Δ PM ‖}_{F} ,$$

where:

each improved configuration or current configuration comprises one or more configuration parameters, i, Pi is a list of values for the configuration parameter i for all of the plurality of nodes, wᵢ is a weight for the configuration parameter i, ΔPM is a list of differences between the first estimate of a performance metric PM and a target for the performance metric PM for each of the plurality of nodes, w_{PM} is a weight for the performance metric PM; and w_{node} is a list of weights for the plurality nodes. This cost value is similar to the initial cost value as described above. However, in this example, all improved configurations and first estimates of performance metrics from step ii) are included in the calculation of the first cost value.

Similarly, to as described for the initial cost value, it will be appreciated that the first cost value may be calculated in different ways and that therefore in some instances a lower first cost value will be considered to be an improvement on a higher cost value, in some instances a higher first cost value will be considered to be an improvement on a lower cost value.
iv) If it is determined that the first cost value does not improve on a second cost value associated with the current configurations, replace a first selected configuration from the improved configurations with the current configuration for the associated node and return to step i). The first selected configuration may comprise improved configuration that provides a smallest improvement in performance for its associated node when compared to other improved configurations.

In other words, if the first cost value indicates that the performance estimated for the improved configurations is worse than performance for the previous current configurations, the one (or more) of the improved configurations is revoked for the node with the least impact (e.g., the lowest or smallest improvement). The method then returns to step i) to evaluate the rest of improved configurations.
v) if it is determined that the first cost value improves on the second cost value associated with the current configurations, set all of the selected configurations used in the previous step i) as the improved configurations.

In other words, the action of revoking an improved configuration for a node with the least impact may be repeated until the performance estimated a group of improved configurations is better than the performance for the previous one. In this way, selected configurations that result in higher improvements are kept in the recommendation list in the current round.

Note that, for the first iteration of step 804, the current configuration are the original configurations for each of the plurality of nodes, but, from the second iteration, the previous configurations of parameters will be the recommendation proposed in the previous one, and so on.

In step 805 the method determines whether or not a new iteration of steps 801 to 804 is required. For example, step 805 may comprise determining whether a maximum number of iterations has been reached. Alternatively, or additionally, step 805 may comprise determining whether the first cost value over previous iterations is converging.

If a new iteration is to be performed the method returns to step 801 in which a new iteration to find the best combination of configurations for all the candidate nodes is run, replacing the current configurations with the improved configurations determined at the end of the previous iteration.

Because of the overlapping recommendations in the same sub-graph, changes to the current configurations in node B will modify target metric on several nodes common to A and B, forcing a recalculation of node A's initial cost value and vice-versa up to convergence of the first cost value for all the plurality of nodes.

It may be determined than no new iteration is to be performed if a threshold number of iterations has been reached (which may be predetermined) or if the same improved configurations (i.e., recommended configurations) have been determined in two iterations sequentially. At this point final recommendations for the configurations may be set as the latest improved configurations in step 806. In some examples, the estimation of the performance in the entire network based on these recommended configurations will also be provided.

These final recommendations for the configurations may then be applied to the plurality of nodes (e.g., implemented in the network).

FIG. 9 illustrates an example of the evolution of the first cost function after each iteration, for 25 iterations. This example is based on the uplink performance scenario in a RAN.

In this example, the one or more performance parameters (initial, current and predicted) comprises SINR values at each of the cells.

It is observed that the aim of the method of FIGS. 7 and 8 is to minimize the first cost value. In this example, the first cost value is reduced from a value of 0.0516 for the initial configuration (i.e., parameter values collected from the real network) in iteration 0 to a value of 0.0434 in iteration 7 for final recommendations. Since no new recommendations are provided from iteration 8 for any of the cells, the process may stop its execution in iteration 8 (after determining that two consecutive iterations provide the same recommendations).

An example of new recommended configurations provided by the process of FIG. 7 or FIG. 8 is shown below in tables 1 to 6, focused on a specific candidate node (e.g., candidate cell).

Table 1 illustrates a list of pZeroNominalPusch and alpha combinations evaluated for each candidate cell in each iteration, sorted by aggressivity, from less (lower pZeroNominalPusch and alpha) to more aggressive (higher pZeroNominalPusch and alpha).

TABLE 1
Combinations of parameters.

| No Combination | pZeroNominalPusch | alpha |
|---|---|---|
| 1 | −106 | 0.9 |
| 2 | −106 | 1 |
| 3 | −103 | 1 |
| 4 | −102 | 1 |
| 5 | −101 | 1 |
| 6 | −100 | 1 |
| 7 | −96 | 1 |
| 8 | −95 | 0.9 |
| 9 | −92 | 0.9 |
| 10 | −92 | 1 |
| 11 | −89 | 0.9 |
| 12 | −88 | 0.9 |
| 13 | −80 | 0.8 |
| 14 | −80 | 0.9 |
| 15 | −80 | 1 |

Table 2 illustrates results achieved in a candidate cell for each combination of parameters (i.e., pZeroNominalPusch and alpha). SINR values of all the cells in the entire network are predicted by executing the GNN, using the corresponding values of pZeroNominalPusch and alpha for this cell, only including in Table 2 the SINR predicted for this candidate cell. Finally, the initial cost value achieved for each combination is computed as described above, using the SINR predicted by GNN for all the cells and pZeroNominalPusch and alpha values used for it.

TABLE 2
Results of parameters evaluation for iteration 1.

| No | | | Cell SINR | Initial cost |
|---|---|---|---|---|
| Combination | pZeroNominalPusch | alpha | predicted | value |
| 1 | −106 | 0.9 | 6.35 | 0.0531 |
| 2 | −106 | 1 | 9.52 | 0.0518 |
| 3 | −103 | 1 | 10.86 | 0.0514 |
| 4 | −102 | 1 | 11.33 | 0.0513 |
| 5 | −101 | 1 | 11.80 | 0.0512 |
| 6 | −100 | 1 | 12.26 | 0.0511 |
| 7 | −96 | 1 | 13.97 | 0.0510 |
| 8 | −95 | 0.9 | 10.78 | 0.0519 |
| 9 | −92 | 0.9 | 11.90 | 0.0519 |
| 10 | −92 | 1 | 15.38 | 0.0512 |
| 11 | −89 | 0.9 | 13.00 | 0.0519 |
| 12 | −88 | 0.9 | 13.35 | 0.0520 |
| 13 | −80 | 0.8 | 11.58 | 0.0535 |
| 14 | −80 | 0.9 | 15.37 | 0.0526 |
| 15 | −80 | 1 | 16.87 | 0.0525 |

As is observed in Table 2, the highest SINR value (16.87 dB) is predicted for combination 15 (pZeroNominalPusch=−80 and alpha=1) but the best initial cost value (0.0510) is achieved for combination 7 (pZeroNominalPusch=−96 and alpha=1) as the aim is to minimize the cost value which considers the impact on neighboring cells and the impact of the pZeroNominalPusch and alpha values.

Table 3 shows results achieved in the candidate cell in the next step once new recommendations for each candidate were proposed in the previous iteration. Now, it is observed that Cell SINR predicted values for each combination of parameters are the same as from previous iteration as (in this particular example) no configuration changes were applied to neighboring cells in the last step, so the GNN uses the same input data for predicting the Cell SINR as before. However, the first cost value calculated in this step is different to values calculated in the previous step as other candidate cells also changed their configurations in the preceding step. The best first cost value (0.0480) is now achieved for combination 10 (pZeroNominalPusch=−92 and alpha=1)

TABLE 3
Results of parameters evaluation for iteration 2.

| No | | | Cell SINR | First cost |
|---|---|---|---|---|
| Combination | pZeroNominalPusch | alpha | predicted | value |
| 1 | −106 | 0.9 | 6.35 | 0.0507 |
| 2 | −106 | 1 | 9.52 | 0.0493 |
| 3 | −103 | 1 | 10.86 | 0.0488 |
| 4 | −102 | 1 | 11.33 | 0.0487 |
| 5 | −101 | 1 | 11.80 | 0.0485 |
| 6 | −100 | 1 | 12.26 | 0.0484 |
| 7 | −96 | 1 | 13.97 | 0.0481 |
| 8 | −95 | 0.9 | 10.78 | 0.0491 |
| 9 | −92 | 0.9 | 11.90 | 0.0489 |
| 10 | −92 | 1 | 15.38 | 0.0480 |
| 11 | −89 | 0.9 | 13.00 | 0.0487 |
| 12 | −88 | 0.9 | 13.35 | 0.0487 |
| 13 | −80 | 0.8 | 11.58 | 0.0500 |
| 14 | −80 | 0.9 | 15.37 | 0.0491 |
| 15 | −80 | 1 | 16.87 | 0.0489 |

Table 4 illustrates the evolution of the recommended configurations (i.e. the improved configurations) achieved for this cell during 15 iterations, where the combination 3 (pZeroNominalPusch=−103 and alpha=1) is the baseline configuration (i.e., the original configuration set in the network) and the final recommendation proposed by the process is the combination 15 (pZeroNominalPusch=−80 and alpha=1). It is observed that the combination 10 is selected from iteration 2 to iteration 4, but from iteration 5 recommendations proposed to other candidate cells affected the first cost value and a new configuration was proposed for the candidate cell.

| Iteration | 0 | 1 | 2 | 3 | 4 | 5 | 6 | 7 | 8 | 9 | 10 | 11 | 12 | 13 | 14 | 15 |
|---|---|---|---|---|---|---|---|---|---|---|---|---|---|---|---|---|
| No Combination | 3 | 7 | 10 | 10 | 10 | 15 | 15 | 15 | 15 | 15 | 15 | 15 | 15 | 15 | 15 | 15 |

TABLE 4
Evolution of parameters selection.

| | | | Cell | Cell | Cell | Cell | Neighs | Neighs | Neighs | Neighs | |
|---|---|---|---|---|---|---|---|---|---|---|---|
| | Baseline | Best | SINR | SINR | SINR | SINR | SINR | SINR | SINR | SINR | List |
| Cell | Conf. | Conf. | Meas. | Pred. | Error | Gain | Meas. | Pred. | Error | Gain | Neighs |
| Cell 1 | (−103, 10) | (−80, 10) | 10.15 | 17.19 | 0.77 | 7.04 | 12.24 | 11.98 | −0.29 | −0.26 | Neigh 1, |
| | | | | | | | | | | | Neigh 2, |
| | | | | | | | | | | | Neigh 3, |
| | | | | | | | | | | | Neigh 4, |
| | | | | | | | | | | | Neigh 5, |
| | | | | | | | | | | | Neigh 6, |
| | | | | | | | | | | | Neigh 7 |

Table 5 shows an example of output report that could be provided by the Search algorithm in the proposed solution, including the following information:

### Table 5—Example of Output for a Cell

Cell: name of the required cell
Baseline Configuration: original pZeroNominalPusch and alpha values configured in the cell.
Best Configuration: final pZeroNominalPusch and alpha values recommended the process.
Cell SINR Measured: SINR of the cell measured in the network.
Cell SINR Predicted: SINR of the cell predicted by GNN using the best configuration.
Cell SINR Error: error of the GNN predicting the SINR using the baseline configuration.
Cell SINR Gain: SINR gain that could be achieved in the cell when the best configuration is set. This value is calculated as the difference between the Cell SINR Predicted and the Cell SINR measured.
Neighbors SINR Measured: Average SINR of neighbors measured in the network.
Neighbors SINR Predicted: Average SINR of neighbors predicted by GNN when the best configuration is set to the required cell.
Neighbors SINR Error: Average SINR error of neighbor using the baseline configuration in the required cell.
Neighbors SINR Gain: Average SINR gain that could be achieved in neighbors when the best configuration is set to the required cell.
List of Neighbors.

The process described above with reference to FIGS. 7 and 8 may be executed several times in multiple timesteps (e.g., every 15-minutes, hourly, daily, weekly, etc.). Regardless of the timestep resolution defined, the process will consider each timestep as an isolated network graph and may provide a recommendation for configurations of the candidate nodes at the end of each timestep. It will be appreciated that each timestep may be executed in parallel for improving the execution time of the process. In other words, since each timestep may considered as an isolated network graph, the process described in FIG. 8 may be executed for each network graph (timestep) in parallel.

Once new recommendations are produced for all the timesteps, a combined, unique recommendation for the configurations of the plurality of nodes (e.g. the pZeroNominalPusch and alpha parameters for each cell) are provided as the final output. A method for selecting the final recommendations may be applied (e.g., either an aggressive selection, a conservative selection, a selection of repeated recommendations, etc.). As final step, the estimation of the performance in the entire network for these final recommendations may be provided by inputting the final configurations into the GNN.

Table 6 illustrates an example of recommendations provided by the process when several timesteps are considered and results achieved when different methods for selecting the final recommendations are applied.

TABLE 6
Example of new recommendations for several timesteps

| | | | | | Most | Most | Most |
|---|---|---|---|---|---|---|---|
| | | | | | aggressive | conservative | repeated |
| Cell | Timestep 1 | Timestep 2 | Timestep 3 | Timestep 4 | combination | combination | combination |
| Cell 1 | (−80, 1) | (−80, 1) | (−80, 1) | (−80, 1) | (−80, 1) | (−80, 1) | (−80, 1) |
| Cell 2 | (−96, 1) | (−100, 1) | (−96, 1) | (−96, 1) | (−96, 1) | (−100, 1) | (−96, 1) |
| Cell 3 | (−80, 1) | (−80, 1) | (−80, 1) | (−80, 1) | (−80, 1) | (−80, 1) | (−80, 1) |
| Cell 4 | (−96, 1) | (−96, 1) | (−92, 0.9) | (−96, 1) | (−92, 0.9) | (−96, 1) | (−96, 1) |
| Cell 5 | (−96, 1) | (−92, 1) | (−92, 1) | (−92, 1) | (−92, 1) | (−96, 1) | (−92, 1) |
| Cell 6 | (−96, 1) | (−92, 1) | (−96, 1) | (−96, 1) | (−92, 1) | (−96, 1) | (−96, 1) |
| Cell 7 | (−92, 1) | (−92, 1) | (−92, 1) | (−92, 1) | (−92, 1) | (−92, 1) | (−92, 1) |
| Cell 8 | (−80, 1) | (−80, 1) | (−80, 1) | (−80, 1) | (−80, 1) | (−80, 1) | (−80, 1) |
| Cell 9 | (−80, 1) | (−80, 1) | (−80, 1) | (−80, 1) | (−80, 1) | (−80, 1) | (−80, 1) |
| Cell 10 | (−95, 0.9) | (−92, 0.9) | (−95, 0.9) | (−95, 0.9) | (−92, 0.9) | (−95, 0.9) | (−95, 0.9) |

It is observed that a different final recommendation per cell may be provided by the process depending on the method applied for selecting it: for cells 2 and 5, different recommendations are achieved depending on whether the mechanism selects the most aggressive or the most conservative combination proposed in any of the timesteps, the most aggressive combination the most repeated one. Whereas cells 4 and 6 are in the same situation but the most conservative combination is the most repeated one. However, cell 10 has different final recommendations as the most aggressive and the most conservative combinations are not the most repeated combination. The rest of cells (i.e., cells 1, 3, 7, 8 and 9) always achieve the same recommendation regardless of the method used for selecting it.

In addition to the aforementioned method described with reference to FIGS. 7 to 9, an alternative approach to find the optimal configurations for the plurality of nodes from the GNN model is described with reference to FIG. 10. In this alternative approach, the gradient of the output with respect to the selected input configurations is calculated and used to iteratively update the configurations across the GNN. During this process, the weights of the GNN are fixed and no changes to the GNN are made.

FIG. 10 illustrates a method of using a graph neural network, GNN, to determine configurations of a plurality of nodes. The GNN may be trained to predict the effect that configurations of the plurality of nodes will have on the collective performance of the plurality of nodes. In particular the GNN may be trained as described with reference to FIGS. 2 to 5.

The method 1000 may be performed by a network node, which may comprise a physical or virtual node, and may be implemented in a computing device or server apparatus and/or in a virtualized environment, for example in a cloud, edge cloud or fog deployment.

In step 1001, the method comprises inputting, in combination, initial performance metrics and current configurations for the plurality of nodes into the GNN.

In step 1002, the method comprises outputting, from the GNN, one or more predicted performance metrics for each of the plurality of nodes.

In step 1003, the method comprises for each node in the plurality of nodes: calculating a gradient by determining a loss function based on the predicted performance metrics and the initial performance metrics. For example, a cost value for the predicted performance metrics (e.g., similar to the first cost value described above) may be compared with a cost value for the initial performance metrics. This may then be used to determine how much the current configurations will improve or degrade the collective performance of the network. Based on this determination, a gradient may be determined to adjust the current configurations by an appropriate amount.

It will be appreciated that the loss function for a first node may be different to the loss function for a second node.

In step 1004, the method comprises updating the current configuration for the node based on the gradient. For example, step 1004 may comprise performing gradient ascent or gradient descent on the current configuration.

Step 1004 is similar to the gradient calculations made during training to update the weights of each hidden layer so that the GNN's predictions become closer to the ground truth values. In the method of FIG. 10, however, the gradient is used to push the configurations of each node in the GNN in a direction that will tend the resulting performance metrics towards performance metrics for which the cost value improves. In some examples, a custom cost value may be used to weight specific nodes more heavily in the optimization or penalize the choice of extreme configurations. During each iteration of this approach, the configurations are updated by either adding (gradient ascent) or subtracting (gradient descent) the calculated gradient after it has been scaled by a pre-defined step-size. These iterations of gradient calculations and configuration updates may then continue until the defined loss function stops improving or an improvement threshold has been achieved.

It will be appreciated that the method of FIG. 10 may be scalable to larger network graphs. For example, gradient calculations are typically much faster than the repeated model predictions. Moreover, a gradient-based approach also allows for the discovery of intermediate configuration settings that may not be included in a training set of configuration settings which may provide a more optimal recommendation. Using the method of FIG. 7 or 8 for such a task may require a grid-search across all possible configuration combinations, which may become unfeasible for large configuration parameter spaces and/or large network graphs.

However, the method of FIG. 10 may be more likely to reach a local optimum rather than a global optimum than the method of FIG. 7 or 8.

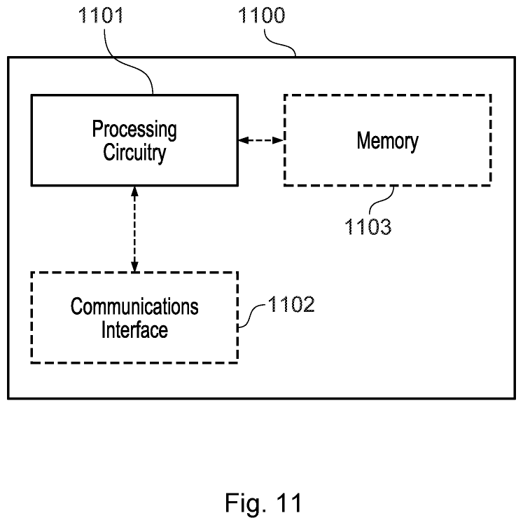

FIG. 11 illustrates a training node 1100 comprising processing circuitry (or logic) 1101. The processing circuitry 1101 controls the operation of the training node 1100 and can implement the method described herein in relation to an training node 1100. The processing circuitry 1101 can comprise one or more processors, processing units, multi-core processors or modules that are configured or programmed to control the training node 1100 in the manner described herein. In particular implementations, the processing circuitry 1101 can comprise a plurality of software and/or hardware modules that are each configured to perform, or are for performing, individual or multiple steps of the method described herein in relation to the training node 1100. The training node 1100 may be implemented at a base station.

Briefly, the processing circuitry 1101 of the training node 1100 is configured to:
input first training information into a first graph convolution layer of the GNN, wherein the first training information comprises: initial performance metrics of the plurality of nodes, subsequent configurations for the plurality of nodes, and an indication of relationships between the plurality of nodes;
apply weighting parameters to the training information in the first graph convolution layer to determine a set of first feature vectors for each of the plurality of nodes;
derive predicted performance metrics for each of the plurality of nodes from the set of first feature vectors; and
update the weighting parameters based a loss function, wherein the loss function is calculated based on: predicted performance metrics associated with a set of training nodes in the plurality of nodes, and actual performance metrics resulting from applying the corresponding subsequent configurations to the set of training nodes.

In some embodiments, the training node 1100 may optionally comprise a communications interface 1102. The communications interface 1102 of the training node 1100 can be for use in communicating with other nodes, such as other virtual nodes. For example, the communications interface 1102 of the training node 1100 can be configured to transmit to and/or receive from other nodes requests, resources, information, data, signals, or similar. The processing circuitry 1101 of training node 1100 may be configured to control the communications interface 1102 of the training node 1100 to transmit to and/or receive from other nodes requests, resources, information, data, signals, or similar.

Optionally, the training node 1100 may comprise a memory 1103. In some embodiments, the memory 1103 of the training node 1100 can be configured to store program code that can be executed by the processing circuitry 1101 of the training node 1100 to perform the method described herein in relation to the training node 1100. Alternatively or in addition, the memory 1103 of the training node 1100, can be configured to store any requests, resources, information, data, signals, or similar that are described herein. The processing circuitry 1101 of the training node 1100 may be configured to control the memory 1103 of the training node 1100 to store any requests, resources, information, data, signals, or similar that are described herein.

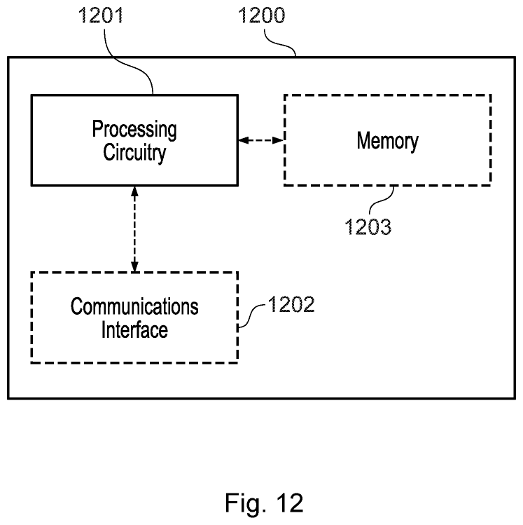

FIG. 12 illustrates a recommender node 1200 comprising processing circuitry (or logic) 1201. The processing circuitry 1201 controls the operation of the recommender node 1200 and can implement the method described herein in relation to a recommender node 1200. The processing circuitry 1201 can comprise one or more processors, processing units, multi-core processors or modules that are configured or programmed to control the recommender node 1200 in the manner described herein. In particular implementations, the processing circuitry 1201 can comprise a plurality of software and/or hardware modules that are each configured to perform, or are for performing, individual or multiple steps of the method described herein in relation to the recommender node 1200. The recommender node 1200 may be implemented at a base station.

Briefly, the processing circuitry 1201 of the recommender node 1200 is configured to:
i) for each first node in a candidate set from the plurality of nodes: utilize the GNN to select a selected configuration from a plurality of test configurations for the first node, whilst considering only changes to the configuration of the first node in conjunction with current configurations for the other of the plurality of nodes,
ii) input, in conjunction, the selected configurations for the candidate set into the GNN;
iii) output, from the GNN, for each of the plurality of nodes, first estimates of one or more performance metrics;
iv) determine, based on the first estimates, one or more improved configurations from the selected configurations that improve a collective estimated performance of the plurality of nodes;
v) update the current configurations for the plurality of nodes with the one or more improved configurations; and
vi) repeat steps i) to v) with the current configurations for the plurality of nodes.

In some embodiments, the recommender node 1200 may optionally comprise a communications interface 1202. The communications interface 1202 of the recommender node 1200 can be for use in communicating with other nodes, such as other virtual nodes. For example, the communications interface 1202 of the recommender node 1200 can be configured to transmit to and/or receive from other nodes requests, resources, information, data, signals, or similar. The processing circuitry 1201 of recommender node 1200 may be configured to control the communications interface 1202 of the recommender node 1200 to transmit to and/or receive from other nodes requests, resources, information, data, signals, or similar.

Optionally, the recommender node 1200 may comprise a memory 1203. In some embodiments, the memory 1203 of the recommender node 1200 can be configured to store program code that can be executed by the processing circuitry 1201 of the recommender node 1200 to perform the method described herein in relation to the recommender node 1200. Alternatively or in addition, the memory 1203 of the recommender node 1200, can be configured to store any requests, resources, information, data, signals, or similar that are described herein. The processing circuitry 1201 of the recommender node 1200 may be configured to control the memory 1203 of the recommender node 1200 to store any requests, resources, information, data, signals, or similar that are described herein.

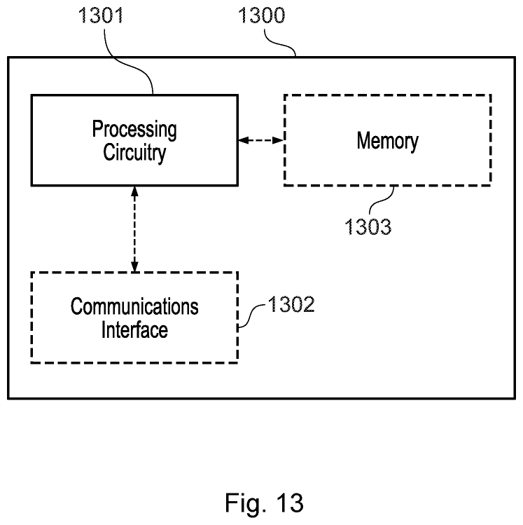

FIG. 13 illustrates a recommender node 1300 comprising processing circuitry (or logic) 1301. The processing circuitry 1301 controls the operation of the recommender node 1300 and can implement the method described herein in relation to an recommender node 1300. The processing circuitry 1301 can comprise one or more processors, processing units, multi-core processors or modules that are configured or programmed to control the recommender node 1300 in the manner described herein. In particular implementations, the processing circuitry 1301 can comprise a plurality of software and/or hardware modules that are each configured to perform, or are for performing, individual or multiple steps of the method described herein in relation to the recommender node 1300. The recommender node 1300 may be implemented at a base station.

Briefly, the processing circuitry 1301 of the recommender node 1300 is configured to:
input, in combination, one or more initial performance metrics and current configurations for the plurality of nodes into the GNN;
output, from the GNN, one or more predicted performance metrics for each of the plurality of nodes; and
for each node in the plurality of nodes:
   calculate a gradient by determining a loss function based on the one or more predicted performance metrics and the one or more initial performance metrics; and
   update the current configuration for the node based on the gradient.

In some embodiments, the recommender node 1300 may optionally comprise a communications interface 1302. The communications interface 1302 of the recommender node 1300 can be for use in communicating with other nodes, such as other virtual nodes. For example, the communications interface 1302 of the recommender node 1300 can be configured to transmit to and/or receive from other nodes requests, resources, information, data, signals, or similar. The processing circuitry 1301 of recommender node 1300 may be configured to control the communications interface 1302 of the recommender node 1300 to transmit to and/or receive from other nodes requests, resources, information, data, signals, or similar.

Optionally, the recommender node 1300 may comprise a memory 1303. In some embodiments, the memory 1303 of the recommender node 1300 can be configured to store program code that can be executed by the processing circuitry 1301 of the recommender node 1300 to perform the method described herein in relation to the recommender node 1300. Alternatively or in addition, the memory 1303 of the recommender node 1300, can be configured to store any requests, resources, information, data, signals, or similar that are described herein. The processing circuitry 1301 of the recommender node 1300 may be configured to control the memory 1303 of the recommender node 1300 to store any requests, resources, information, data, signals, or similar that are described herein.

There is also provided a computer program comprising instructions which, when executed by processing circuitry (such as the processing circuitry 1101 of the training node 1100 described earlier), cause the processing circuitry to perform at least part of the method described herein. There is provided a computer program product, embodied on a non-transitory machine-readable medium, comprising instructions which are executable by processing circuitry to cause the processing circuitry to perform at least part of the method described herein. There is provided a computer program product comprising a carrier containing instructions for causing processing circuitry to perform at least part of the method described herein. In some embodiments, the carrier can be any one of an electronic signal, an optical signal, an electromagnetic signal, an electrical signal, a radio signal, a microwave signal, or a computer-readable storage medium.

Embodiments described herein provide methods and apparatuses that allow for a single configuration recommendation to provide configurations for an entire graph of nodes (e.g. an entire network). The embodiments are able to deal with overlapping proposals and can pre-estimate in advance the impact of recommended configurations on a source node and influencing neighbor nodes.

The proposed GNN is configured to better learn the inter-relation of neighboring nodes and is able to generalize better compared to NN approach. Each node in the GNN of embodiments described herein may have any number of neighbors, which is more flexible for highly dense areas, for example, in networks with many cells in close proximity. The GNN according to embodiments described herein is also able to handle scenarios when the neighbor nodes located two or more hops away from a node are influencing the performance of the node.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1. A computer-implemented method of a training a graph neural network, GNN, comprising a plurality of nodes and a plurality of edges, the method comprising:
inputting first training information into a first graph convolution layer of the GNN, wherein the first training information comprises: initial performance metrics of the plurality of nodes, subsequent configurations for the plurality of nodes, and an indication of relationships between the plurality of nodes;
applying weighting parameters to the training information in the first graph convolution layer to determine a set of first feature vectors for each of the plurality of nodes;
deriving predicted performance metrics for each of the plurality of nodes from the set of first feature vectors; and
updating the weighting parameters based on a loss function, wherein the loss function is calculated based on: predicted performance metrics associated with a set of training nodes in the plurality of nodes, and actual performance metrics resulting from applying the corresponding subsequent configurations to the set of training nodes.

2. The computer-implemented method of claim 1, wherein the first training information comprises one or more of:
a first matrix comprising the subsequent configurations of the plurality of nodes and the initial performance metrics of the plurality of nodes;
a second matrix comprising the indication of relationships between the plurality of nodes; and
a third matrix comprising relationship performance metrics associated with the relationships between the plurality of nodes.

3. The computer-implemented method of claim 2, wherein step of applying weighting parameters comprises:
determining a first feature vector for a first node by:
applying a first weighting parameter to a first vector of information in the first matrix associated with the first node.

4. The computer-implemented method as claimed in claim 3, wherein the step of determining the first feature vector for the first node further comprises:
for each neighboring node of the first node:
determining a second vector of information in the first matrix associated with the neighboring node, and
multiplying the second vector an output of a Multi-layer Perceptron, MLP, wherein MLP receives the relationship performance metrics of the relationship between the first node and the neighboring node as an input, to determine a third vector.

5. The computer-implemented method as claimed in claim 4, wherein the step of determining the first feature vector for the first node further comprises:
calculating the first feature vector as a sum of: the third vectors for all neighboring nodes of the first node, the weighted first vector, and an offset value.

6. The computer-implemented method of claim 4, wherein the step of updating the weighting parameters comprises updating the first weighting parameter and updating the parameters in the MLP.

7. The computer-implemented method of claim 1, wherein the step of deriving predicted performance metrics for each of the plurality of nodes from the first set of feature vectors comprises:
inputting the set of first feature vectors into a second graph convolution layer.

8. The computer-implemented method of claim 1, further comprising:
testing an accuracy of the GNN utilizing first training information associated with one or more of the plurality of nodes not in the set of training nodes.

9. The computer-implemented method of claim 1, wherein the step of updating the weighting parameters further comprises:
for each of the set of training nodes:
determining a node weighting value derived from a rarity of the subsequent configuration for the training node;
determining a weighted comparison by applying the node weighting value to a comparison between predicted performance metrics for the training node and actual performance metrics for the training node; and
using the weighted comparison in the loss function.

10. The computer-implemented method of claim 1, wherein the first training data is collected over a first time period.

11. The computer-implemented method of claim 10, wherein the first time period comprises one of: one day, one week or one hour.

12. The computer-implemented method of claim 1, wherein each of the plurality of nodes represents a node in a telecommunications network, and each of the plurality of edges represents a relationship between two nodes in the telecommunications network.

13. The computer-implemented method of claim 12, wherein the subsequent configurations comprise values of: a target uplink received power and a pathloss compensation factor.

14. The computer-implemented method of claim 12, wherein the predicted performance metrics and actual performance metrics comprise one or more of values of: average throughput, total data volume, average pathloss, average active users, average uplink noise level, average channel quality indicator, and average signal to noise plus interference ratio (SINR).

15.-21. (canceled)

22. A computer-implemented method of using a graph neural network, GNN, to determine recommended configurations for a plurality of nodes, wherein the GNN comprises the plurality of nodes and a plurality of edges, the method comprising:
i) for each first node in a candidate set from the plurality of nodes:
utilizing the GNN to select a selected configuration from a plurality of test configurations for the first node, whilst considering only changes to the configuration of the first node in conjunction with current configurations for the other of the plurality of nodes,
ii) inputting, in conjunction, the selected configurations for the candidate set into the GNN;
iii) outputting, from the GNN, for each of the plurality of nodes, first estimates of one or more performance metrics;
iv) determining, based on the first estimates, one or more improved configurations from the selected configurations that improve a collective estimated performance of the plurality of nodes;
v) updating the current configurations for the plurality of nodes with the one or more improved configurations; and
vi) repeating steps i) to v) with the current configurations for the plurality of nodes.

23.-42. (canceled)

43. A computer-implemented method of using a graph neural network, GNN, to determine configurations of a plurality of nodes, wherein the GNN comprises the plurality of nodes and a plurality of edges, the method comprising:
inputting, in combination, one or more initial performance metrics and current configurations for the plurality of nodes into the GNN;
outputting, from the GNN, one or more predicted performance metrics for each of the plurality of nodes; and
for each node in the plurality of nodes:
calculating a gradient by determining a loss function based on the one or more predicted performance metrics and the one or more initial performance metrics; and
updating the current configuration for the node based on the gradient.

44.-56. (canceled)

57. A training node for training a graph neural network, GNN comprising a plurality of nodes and a plurality of edges, the training node comprising processing circuitry configured to cause the training node to carry out the method according to claim 1.

58. (canceled)

59. A recommender node for using a graph neural network, GNN, to determine recommended configurations for a plurality of nodes, wherein the GNN comprises the plurality of nodes and a plurality of edges, the recommender node comprising processing circuitry configured to carry out the method according to claim 22.

60. (canceled)

61. A recommender node for using a graph neural network, GNN, to determine recommended configurations for a plurality of nodes, wherein the GNN comprises the plurality of nodes and a plurality of edges, the recommender node comprising processing circuitry configured to carry out the method according to claim 43.

62. (canceled)

63. A computer program product comprising a non-transitory computer readable medium storing a computer program comprising instructions which, when executed on processing circuitry, cause the processing circuitry to carry out a method according to claim 1.

64. (canceled)
